(19) United States
(12) Patent Application Publication
(10) Pub. No.: US 2025/0338146 A1
(43) Pub. Date: Oct. 30, 2025

(54) LARGE CHANNEL MODEL

(71) Applicant: Samsung Electronics Co., Ltd., Suwon-si (KR)

(72) Inventors: Lianjun Li, McKinney, TX (US); Hao Chen, Allen, TX (US); Daoud Burghal, San Jose, CA (US); Jianzhong Zhang, Dallas, TX (US)

(21) Appl. No.: 19/033,375

(22) Filed: Jan. 21, 2025

Related U.S. Application Data
(60) Provisional application No. 63/638,349, filed on Apr. 24, 2024.

(51) Int. Cl. H04W 24/02; H04W 28/02

(52) U.S. Cl. CPC H04W 24/02; H04W 28/0236

(57) ABSTRACT

Apparatuses and methods of solving wireless communication tasks. A method includes receiving, at an electronic device, a wireless channel model trained based on task-independent data; obtaining task-dependent data; determining, based on the wireless channel model and the task-dependent data, a task-independent metric and a task-dependent metric; and combining the task-independent metric and the task-dependent metric to solve wireless communication tasks.

### CROSS-REFERENCE TO RELATED APPLICATION AND CLAIM OF PRIORITY

The present application claims priority under 35 U.S.C. § 119(e) to U.S. Provisional Patent Application No. 63/638,349 filed on Apr. 24, 2024, which is hereby incorporated by reference in its entirety.

### TECHNICAL FIELD

This disclosure relates generally to wireless communication systems. More specifically, this disclosure relates to a large channel model for solving wireless communication tasks.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides a large channel model for solving wireless communication tasks in wireless communication systems.

In one embodiment, a method includes: receiving, at an electronic device, a wireless channel model trained based on task-independent data; obtaining task-dependent data; determining, based on the wireless channel model and the task-dependent data, a task-independent metric and a task-dependent metric; and combining the task-independent metric and the task-dependent metric to solve wireless communication tasks.

In another embodiment, an electric device includes: a memory configured to receive a wireless channel model trained based on task-independent data; and a processor operably coupled to the memory. The processor is configured to: obtain task-dependent data; determine, based on the wireless channel model and the task-dependent data, a task-independent metric and a task-dependent metric; and combine the task-independent metric and the task-dependent metric to solve wireless communication tasks.

In yet another embodiment, a non-transitory computer readable medium embodying a computer program is provided. The computer program includes program code that, when executed by a processor of an electronic device, causes the electronic device to: receive a wireless channel model trained based on task-independent data; obtain task-dependent data; determine, based on the wireless channel model and the task-dependent data, a task-independent metric and a task-dependent metric; and combine the task-independent metric and the task-dependent metric to solve wireless communication tasks.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example base station according to embodiments of the present disclosure;

FIG. 3 illustrates an example user equipment according to embodiments of the present disclosure;

FIG. 4 illustrates an example network device according to embodiment of the present disclosure;

FIG. 5 illustrates a block diagram of deploying an example large channel model in a wireless network according to embodiments of the present disclosure;

FIG. 6 illustrates a system process flow of a method for solving wireless communication tasks based at least in part on a large channel model according to embodiments of the present disclosure;

FIG. 7 illustrates an example posterior sample procedure utilized in solving wireless communication tasks based at least in part on a large channel model according to embodiments of the present disclosure;

FIG. 8 illustrates an example channel estimation task being solved based at least in part on a large channel model according to embodiments of the present disclosure;

FIG. 9 illustrates an example channel prediction task being solved based at least in part on a large channel model according to embodiments of the present disclosure; and

FIG. 10 illustrates an example flow chart for a method of solving wireless communication tasks based at least in part on a large channel model according to embodiments of the present disclosure.

### DETAILED DESCRIPTION

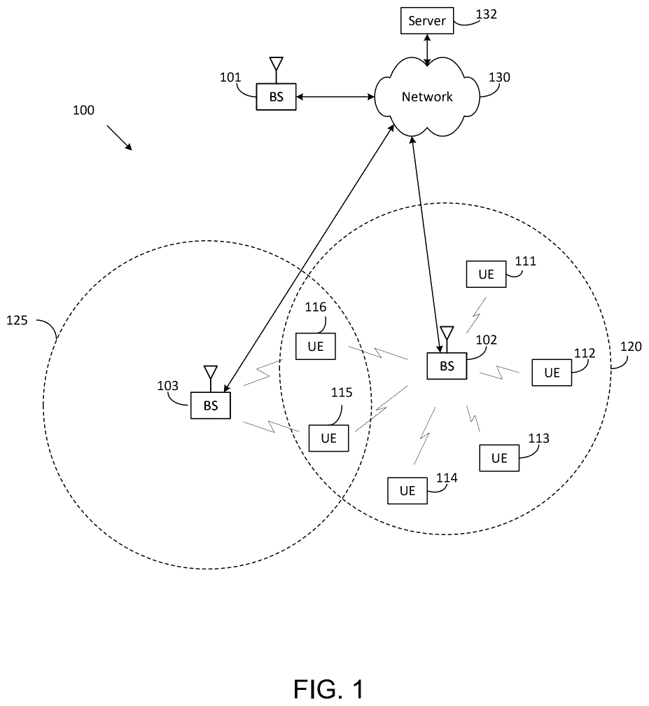

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB (e.g., base station, BS) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

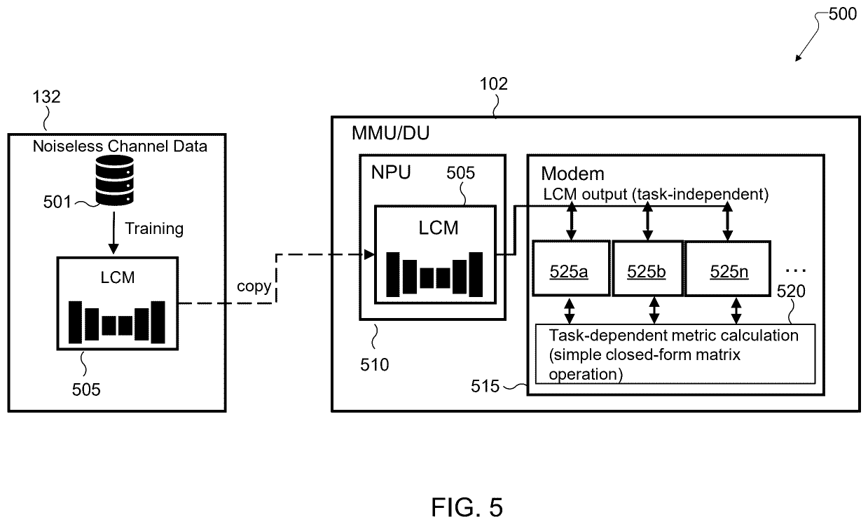

The wireless network 100 may be an artificial intelligence (AI)-based cellular system. As such, the at least one network 130 may be operably coupled to a network device (e.g., without limitation, a server) 132 configured to, for example and without limitation, prepare training data and train a large channel model (also referred to herein as an AI model or a wireless channel model) based on the training data (e.g., without limitation, task-independent data such as noiseless channel data). The server 132 may represent one or more servers, and each server 132 includes a suitable computing or processing device for preparing the training data and training the large channel model. Each server 132 could, for example, include one or more processing devices, one or more memories storing instructions and data, and one or more network interfaces to receive the data from, e.g., without limitation, gNBs 101-103. Upon training, the large channel model may be then copied (hosted or deployed) to a gNB 101-103 to solve multiple wireless communications tasks as described further in detail with reference to FIGS. 5-9.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support the gNB 101-103 for performing wireless communications tasks. In certain embodiments, one or more of the gNBs 101-103 include circuitry, programing, or a combination thereof, to perform wireless communications tasks using the large channel model.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

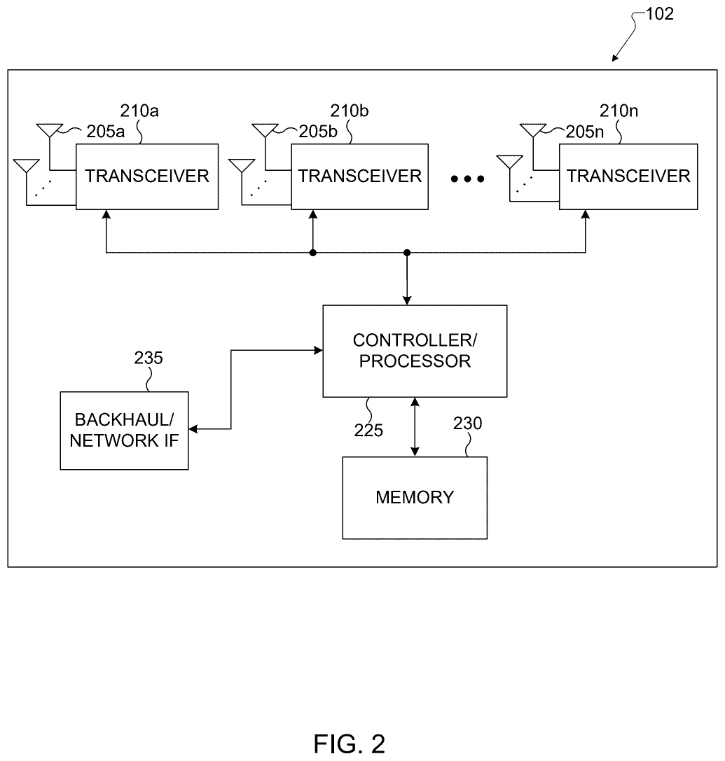

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to solve wireless communications tasks based at least in part on a large channel model as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

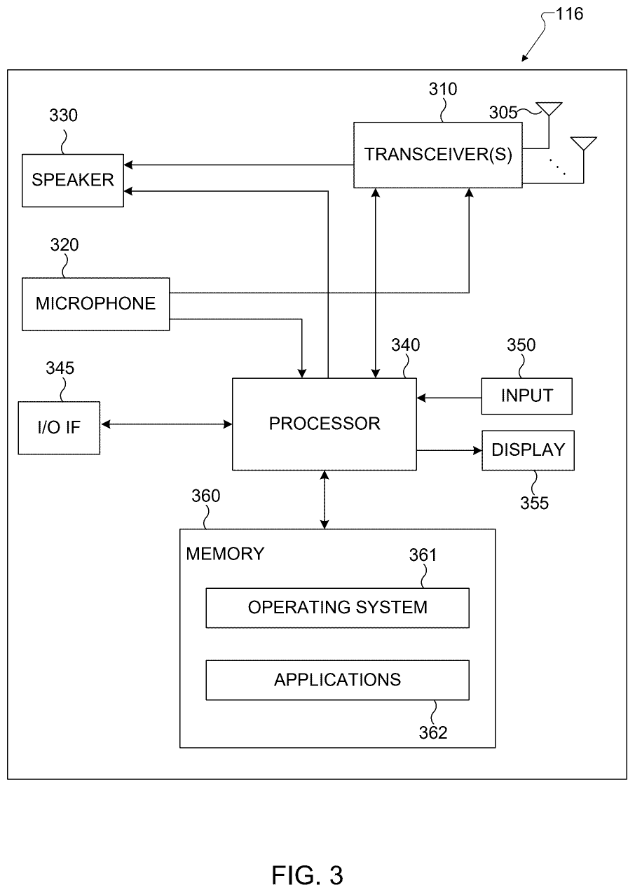

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to provide data to gNBs for solving wireless communication tasks based at least in part on a large channel model as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

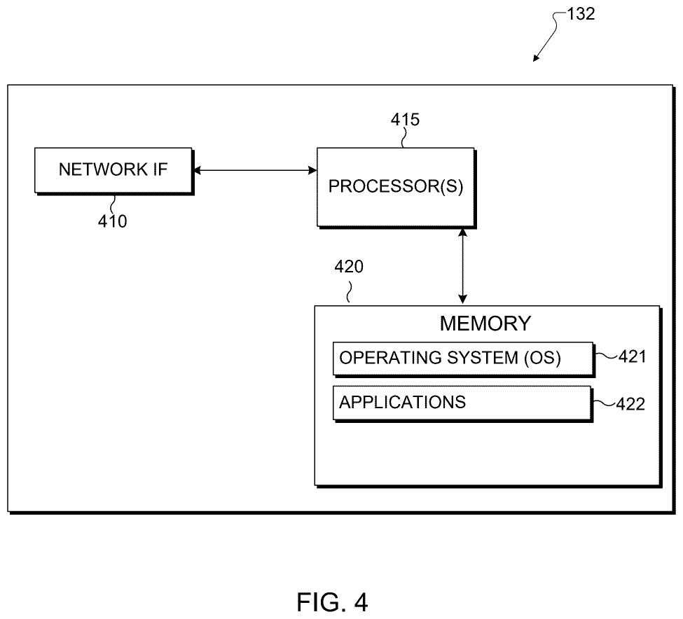

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410, the UEs 111-116 via the gNBs 101-103, or any other appropriate sources. The server 132 may also prepare training data based on simulations and/or real measurements. The training data may be task-independent data such as noiseless wireless channel data. The server 132 may then train the large channel model based on the task-independent data and deploy the large channel model in a base station via the network interface 410.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network such as the large channel model as well as a CPU, a GPU or a tensor processing unit (TPU) that provides significant computational resources required for training the large channel model.

The processor 415 is also capable of executing other processes and programs resident in the memory 420, such as operations that receive and store data. As described in greater detail below, the processor 415 may execute processes to receive data from the gNBs 101-103, the UEs 111-116 or any other appropriate sources, prepare training data for the large channel model, and train the large channel model to solve wireless communications tasks including channel prediction, channel estimation, channel interpolation, etc., as long as each task is related to a channel in wireless communication and can be formulated as a linear inverse problem (y=Ax+n). The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for the large channel model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

Each of these discussed transmitted, received, and/or calculated parameters or metrics are examples of data that may be utilized in training the large channel model and/or solving wireless communication tasks in various embodiments of the present disclosure.

In modern wireless systems, such as those described regarding FIGS. 1-4, AI models may be utilized for solving difficult wireless communication tasks. While AI-based solutions for wireless communication problems have been extensively studied in recent years and demonstrated promising performances as compared to the solutions based on the conventional non-AI-based approaches, the current AI solutions may be isolated and inefficient since they utilize individual neural networks (NNs) that are tailored to specific tasks and trained using data specifically formatted for those tasks. Thus, implementing the current AI-based solutions in practice necessitates the inclusion of several distinct, task-specific modules within a base station, for example and without limitation, separate modules specifically trained to solve channel estimation, channel prediction, symbol detection and so forth. The separation of the AI modules inevitably leads to a low efficiency in the NN training process and hardware memory utilization. Although an AI solution in which a single trained AI model may handle multiple wireless communication tasks would offer a significant improvement over the current task-specific AI solutions, developing such a solution has faced substantial challenges. The present disclosure resolves these problems and challenge and describes a large channel model capable of handling multiple wireless communication tasks in parallel. In particular, the example large channel model in accordance with the present disclosure needs only noiseless wireless channel samples as training data. Once trained, the large channel model is capable of handling multiple wireless communication tasks simultaneously, thereby significantly reducing the complexity of preparing training data and enhancing the hardware utilization efficiency. The large channel model may be trained at a network side based on task-independent data and deployed at a base station. Upon deployment, the large channel model outputs a task-independent metric and the base station may then combine the task-independent metric with a task-dependent metric(s) calculated locally to solve wireless communication tasks including channel prediction, channel estimation, channel interpolation, etc., so long as the wireless communication task is related to a channel in wireless communications and can be formulated as a linear inverse problem (y=Ax+n), as discussed further in detail with reference to FIGS. 5-9.

FIG. 5 illustrates an example block diagram 500 of deploying an example large channel model 505 in a base station 102 in a wireless network according to embodiments of the present disclosure. The base station 102 may include memory and a processing unit having e.g., without limitation, a neural processing unit (NPU) 510 and a central processing unit (CPU) 515. The embodiment of the base station 102 in FIG. 5 is for illustration only. Other embodiments of a base station 102 configured to perform wireless communication tasks using the large channel model 505 may be used without departing from the scope of this disclosure.

As shown in FIG. 5, the large channel model 505 may be trained offline based on training data 501 at a network device such as the server 132 of FIGS. 1 and 4. The training data 501 may be wireless channel samples obtained through, e.g., without limitation, simulations and real measurements. The wireless channel samples are task-independent data, e.g., without limitation, noiseless wireless channel data, ground truth or pure channel data. Upon training, the large channel model 505 may be copied onto a processing unit of the base station 102. The processing unit may be a processing unit of, for example and without limitation, a massive MIMO unit (MMU)/digital unit (DU) of the base station 102 and include an NPU 510 and a CPU 515. The CPU 515 may be configured to control the operation of the base station 102 and perform task-dependent wireless communication tasks. The large channel model 505 may be deployed on the NPU 510 for resource-intensive online inference. The base station 102 may perform (e.g., without limitation, solve or resolve) wireless communication tasks 525a-n based on the large channel model 505 and a task-dependent data. The base station 102 may first obtain the task-dependent data and then input the task-dependent data to the large channel model 505 and the CPU 515. Based on the task-dependent data, the large channel model 505 may calculate a task-independent metric and the CPU 515 may calculate a task-dependent metric 520. Due to its simplicity, the task-dependent metric may be calculated within the CPU 515. The base station 102 (e.g., the CPU 515) may then combine the task-independent metric and the task-dependent metric and solve the wireless communication tasks 525a-n in parallel.

The wireless communication tasks 525a-n may be expressed as a linear inverse problem as follows:

$$y = Ax + n$$

where A is a known linear matrix, n is a Gaussian noise, and y is the noisy observation of x. The objective of a wireless communication task is to retrieve x (a noiseless parameter, ground truth or pure channel state) from its noisy observation y. The matrix A defines the nature of the linear inverse problem at hand. For example, if A is an identity matrix, the wireless communication task corresponds to a denoising problem. In another example, if A is a subsampling operator, the wireless communication task becomes a prediction problem. In yet another example, if A is SB (S being a subsampling operator and B being a blurring operation corresponding to convolution with a blur kernel), the wireless communication task becomes a super resolution or channel interpolation problem. The optimal approach to solving linear inverse problems may be Maximum A Posteriori (MAP) estimation:

$$\hat{x} = arg {max}_{x} p ( x \vert y ) = arg {max}_{x} p ( x ) p ( y \vert x )$$

where x is the value of x believed to best represent the true state of x given the observation y, p(x|y) is the likelihood or probability of x given y, argmaxₓ p(x|y) is the value of x that maximizes the probability of x given y. By decomposing the posterior p(x|y) into the prior p(x) and the likelihood p(y|x), this equation unveils the potential to address multiple tasks using the large channel model 505, i.e., a single AI model. Notably, the prior p(x) is shared across all tasks, which may be learned by the large channel model 505, which may be a diffusion model. As for the likelihood p(y|x), although it is task-dependent (i.e., dependent on A), due to the linear property of A and the known noise distribution, it may be easily calculated in a closed form. To simplify mathematical operations, argmaxₓ log p(x|y) may be used as an equivalent to argmaxₓp(x|y). Further, argmaxₓ log p(x|y) may be need for application of the gradient ascent optimization.

As previously mentioned, the large channel model 505 may be a diffusion model that learns derivative (also referred to herein as a gradient) of log probability of a wireless channel x, denoted as ∇ₓ log p (x) and referred to as a score function. When applied to downstream tasks, the large channel model 505 may be employed for posterior sampling, generating channel samples from p(x|y). Sample generation is an iterative process that relies on the calculation of a posterior score function:

$${∇}_{x} log p ( x \vert y ) = {∇}_{x} log p ( x ) + {∇}_{x} log p ( y \vert x )$$

where the score function ∇ₓ log p (x) is obtained from the large channel model 505, while the likelihood score ∇ₓ log p (y|x) can be easily approximated by the CPU 515 in a closed-form expression as follows:

$${∇}_{{x}_{t}} log p ( y \vert {x}_{t} ) \approx \frac{1}{\sqrt{{\overline{α}}_{t}}} {{A}^{T} ( {σ}^{2} I + \frac{1 - {\overline{α}}_{t}}{{\overline{α}}_{t}} {AA}^{T} )}^{- 1} ( y - \frac{1}{\sqrt{{\overline{α}}_{t}}} {Ax}_{t} ) \qquad EQ . 1$$

where t is the iterative step or time step number.

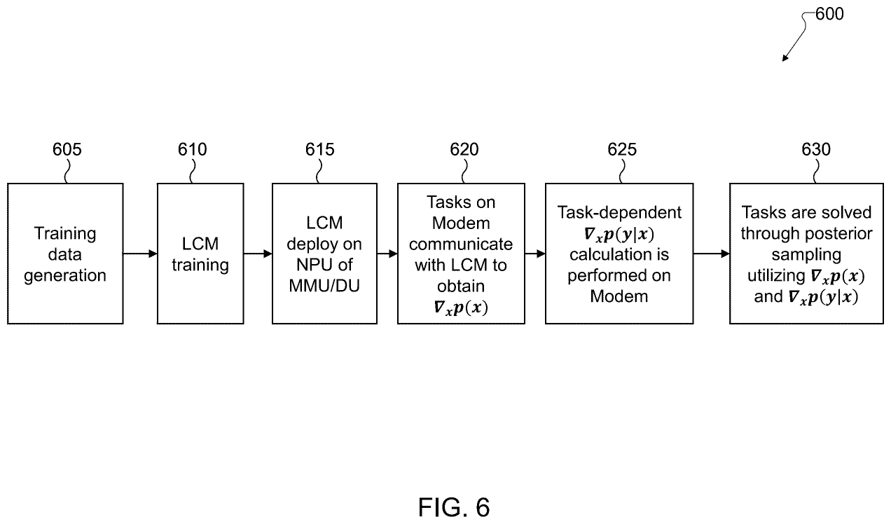

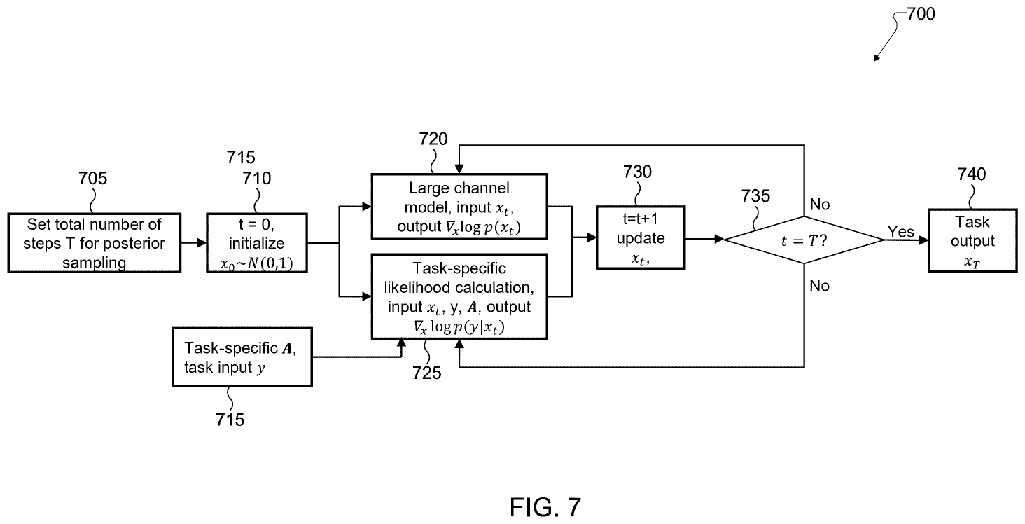

FIG. 6 illustrates a system process flow of a method 600 for solving wireless communication tasks according to embodiments of the present disclosure. The large channel model may be the large channel model 505 as described with reference to FIG. 5. As illustrated in FIG. 6, the method 600 begins at step 605. At step 605, training data for the large channel model is generated at a server. The training data may be wireless channel samples of a wireless channel(s), which may be obtained through simulations and/or real measurements. The wireless channel may reside in time (OFDM symbol), frequency (subcarrier), and space (antenna) dimensions. Thus, the training data may contain all or a subset of the three dimensions, depending on the specific problem setup. At step 610, the large channel model is trained based on the training data. The large channel model may be a diffusion model and trained by well-known diffusion model training methods such as the Denoising Diffusion Probabilistic Models or Score Matching method. The training may be performed offline on a server. At 615, the trained large channel model may be hosted (copied or deployed) on a neural processing unit (NPU) within a base station. At 620, a central processing unit (CPU) within the base station communicates with the large channel model to obtain ∇ₓp(x), which is common for all wireless communication tasks, i.e., a task-independent metric. At 625, the CPU calculates ∇ₓp(y|x), which is specific to each task, i.e., a task-dependent metric. Task-dependent ∇ₓp(y|x) is a simple closed-form matrix operation. At 630, the base station (the CPU) solves the wireless communication tasks based on a posterior sampling procedure utilizing the task independent metric ∇ₓp(y|x) and the task-dependent metric ∇ₓp(y|x). The posterior sampling procedure is discussed further in detail with reference to FIG. 7.

FIG. 7 illustrates an example posterior sampling procedure 700 utilized in solving wireless communication tasks based at least in part on a large channel model according to the embodiments of the present disclosure. As previously mentioned, the large channel model is trained on task-independent data, and thus task-agnostic. Thus, once trained, the large channel model may be used to support multiple tasks simultaneously. Further, as it is task-agnostic, only one physical copy of the large channel model is required in the base station. The one copy of the large channel model may then function as multiple virtual copies, each serving a specific wireless communication task. Each wireless communication task is formulated as a linear inverse problem (y=Ax+n) with task specific matrix A, given task input y, and the output is generated by the posterior sampling procedure 700. As mentioned previously, the MAP estimation is the optimal approach to solving a linear inverse problem and MAP is solved by updating x iteratively. This iterative procedure may be a posterior sampling procedure.

As illustrated in FIG. 7, the posterior sampling procedure 700 begins at step 705. At step 705, the base station sets the total number of iterative steps T for the posterior sampling procedure. At step 710, the base station initializes x₀ as a Gaussian noise (i.e., x₀˜N(0,1)), where x₀ is a sample xₜ at time step 0. At step 715, the base station inputs task-specific matrix A and task input y to a central processing unit (CPU). At step 720, the base station inputs xₜ to the large channel model to generate ∇ₓ log p (xₜ). At step 725, the CPU calculates the task-specific likelihood ∇ₓ log p (y|xₜ) given task input y, task specific A, and current sample xₜ, following established methods such as EQ. 1. At step 730, the base station increases t by 1, updates xₜ towards the direction of ∇ₓ log p (xₜ) and ∇ₓ log p (y|xₜ) following:

$${x}_{t + 1} = \frac{1}{\sqrt{{α}_{t}}} ( {x}_{t} + ( 1 - {α}_{t} ) {∇}_{x} log p ( {x}_{t} ) ) + \sqrt{1 - {α}_{t} {z}_{t}} + λ \frac{1 - {α}_{t}}{\sqrt{{α}_{t}}} {∇}_{{x}_{t}} log p ( y \vert {x}_{t} ) .$$

At step 735, the base station determines whether t=T. If yes, the base station terminates the iteration and outputs xₜ as task output. If no, the base station returns to steps 720 and 725.

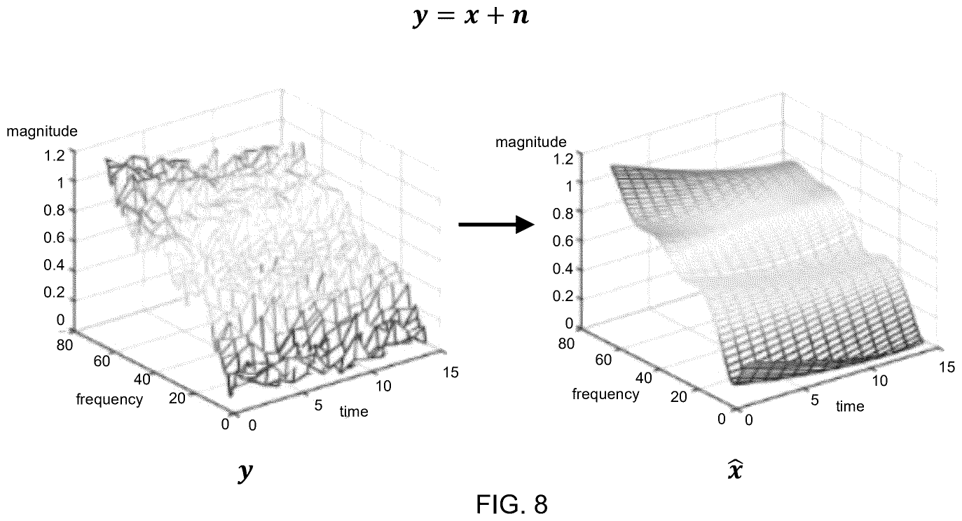

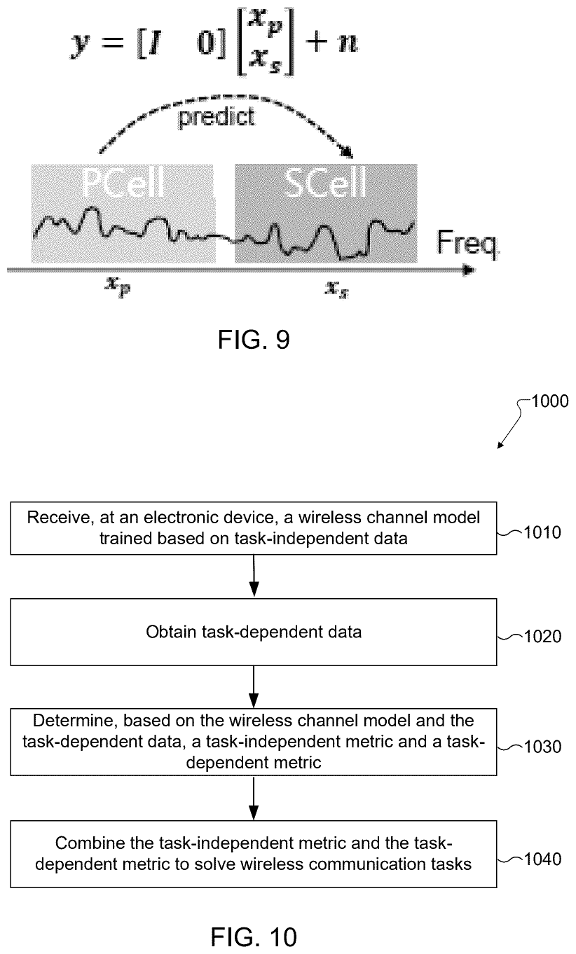

FIGS. 8 and 9 illustrate example wireless communication tasks being solved based at least in part on an example large channel model according to embodiments of the present disclosure. FIG. 8 illustrates a channel estimation task being solved and FIG. 9 illustrates a channel prediction task being solved based at least in part on the large channel model. A channel estimation problem may be formulated as y=Ix+n, where I is the identity matrix, y is the least square channel estimates, x is the ground truth channel, and n is Gaussian noise. The goal is to recover x (a noiseless channel) from y. The task-independent metric □ₓ log p(x) may be obtained through the large channel model. Given A=I, the task-dependent metric ∇ₓ_{ₜ} log p(y|xₜ) for channel estimation may be calculated as follows:

$${∇}_{{x}_{t}} log p ( y \vert {x}_{t} ) \approx \frac{1}{\sqrt{\overline{{α}_{t}}}} {( {σ}^{2} + \frac{1 - \overline{{α}_{t}}}{\overline{{α}_{t}}} )}^{- 1} ( y - \frac{1}{\sqrt{\overline{{α}_{t}}}} {x}_{t} )$$

The posterior sampling procedure may be performed as follows:

$${x}_{t + 1} = \frac{1}{\sqrt{{α}_{t}}} ( {x}_{t} + ( 1 - {α}_{t} ) {∇}_{x} log p ( {x}_{t} ) ) + \sqrt{1 - {α}_{t}} {z}_{t} + λ \frac{1 - {α}_{t}}{\sqrt{{α}_{t}}} {∇}_{{x}_{t}} log p ( y \vert {x}_{t} )$$

A channel prediction problem includes a secondary cell prediction problem, which may be formulated as

$$y = [ \begin{matrix}I & 0\end{matrix} ] [ \begin{matrix}{x}_{p} \\ {x}_{s}\end{matrix} ] + n ,$$

where xₚ is a channel in a primary cell frequency band, xₛ is a channel in a secondary cell frequency band, y is the least square estimated channel in the primary cell, and n is Gaussian noise. The goal is to recover xₛ from y. The task-independent metric ∇ₓ log p(x) may be obtained through the large channel model. Given A=[I 0], ∇ₓ_{ₜ} log p(y|xₜ) may be calculated as follows:

$${∇}_{{x}_{t}} log p ( y \vert {x}_{t} ) \approx {\frac{1}{\sqrt{\overline{{α}_{t}}}} [ \begin{matrix}I & 0\end{matrix} ]}^{T} {( {σ}^{2} + \frac{1 - \overline{{α}_{t}}}{\overline{{α}_{t}}} )}^{- 1} ( y - \frac{1}{\sqrt{\overline{{α}_{t}}}} [ \begin{matrix}I & 0\end{matrix} ] {x}_{t} )$$

The posterior sampling procedure may be performed as follows:

$${x}_{t + 1} \frac{1}{\sqrt{{α}_{t}}} ( {x}_{t} + ( 1 - {α}_{t} ) {∇}_{x} log p ( {x}_{t} ) ) + \sqrt{1 - {α}_{t}} {z}_{t} + λ \frac{1 - {α}_{t}}{\sqrt{{α}_{t}}} {∇}_{{x}_{t}} log p ( y \vert {x}_{t} )$$

It is noted that the large channel model may be trained with simulated channel samples generated following the 3GPP CDL-C channel model. Regarding the posterior sampling procedure, a denoising diffusion implicit model (DDIM) with T=200 may be used for the large channel model result. The channel estimation and secondary cell prediction performances in terms of normalized mean square error (NMSE) have been demonstrated using moving average (MA), linear minimum mean square error (LMMSE), and an example large channel model (DDIM-200). It has been observed that for channel estimation, the large channel model achieved nearly the same performance as the existing optimal LMMSE method, and for the secondary cell prediction performance, the large channel model using DDIM also outperformed the state-of-the-art AI solution.

FIG. 10 illustrates an example flow chart for a method 1000 of performing wireless communication tasks based on an example large channel model according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of data preparation could be used without departing from the scope of this disclosure.

As illustrated in FIG. 10, the method 1000 begins at step 1010. At step 1010, an electronic device (e.g., without limitation, a base station 101-103 of FIGS. 1 and 2) receives a wireless channel model trained based on task-independent data. In one embodiment, the large channel model is trained offline at a network device operably coupled to the electronic device. In one embodiment, the task-independent data includes noiseless wireless channel data.

At step 1020, the base station obtains task-dependent data.

At step 1030, the base station determines, based on the wireless channel model and the task-dependent data, a task-independent metric and a task-dependent metric. In one embodiment, determining a task-independent metric and a task-dependent metric includes: performing Maximum A Posteriori (MAP) estimation to determine a target information for a wireless communication task based on a gradient ascent optimization; calculating, by the wireless channel model, a gradient of logarithmic probability of the target information for a wireless communication task; and calculating a gradient of logarithmic probability of observing the task-dependent data given the target information, the task-dependent data indicative of the target information, observed at the electronic device, being linearly transformed by a task-dependent matrix and corrupted by a noise.

In one embodiment, the method 1000 further includes determining a target information for a wireless communication task based on an iterative sampling procedure by: defining a number of iterative steps; initializing a sample target information as a noise; updating the sample target information based on the task-independent metric and task-dependent metric at each iterative step; and determining that the target information is last updated sample target information at last iterative step.

At step 1040, the base station combines the task-independent metric and the task-dependent metric to solve wireless communication tasks. The wireless communication tasks include channel prediction, channel estimation, channel interpolation, etc., as long as each task is related to a channel in wireless communication and can be formulated as a linear inverse problem (y=Ax+n), where A is a known linear matrix, n is a Gaussian noise, and y is the noisy observation of x.

In one embodiment, the wireless communication task is channel estimation, and the task-dependent data is a noisy wireless channel indicative of a noiseless wireless channel, observed at the electronic device, being linearly transformed by an identity matrix and corrupted by a noise. In this embodiment, the method 1000 may further include: calculating, by the wireless channel model, a gradient of logarithmic probability of the noiseless wireless channel; calculating a gradient of logarithmic probability of observing the noisy wireless channel given the noiseless wireless channel; updating a sample noiseless wireless channel based on the gradients for a defined number of iterations; and determining the noiseless wireless channel based on last updated sample noiseless wireless channel at last iteration.

In another embodiment, the wireless communication task is channel prediction, and the task-dependent data is a noisy primary cell channel indicative of a noiseless primary cell channel, observed at the electronic device, being linearly transformed by a subsampling operator and corrupted by a noise. In this embodiment, the method 1000 may further include: determining the noiseless primary cell channel in frequency domain based on Maximum A Posteriori (MAP) estimation and a gradient ascent optimization; and predicting a secondary cell channel in the frequency domain based at least in part on the determined noiseless primary cell channel.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A computer-implemented method comprising:
receiving, at an electronic device, a wireless channel model trained based on task-independent data;
obtaining task-dependent data;
determining, based on the wireless channel model and the task-dependent data, a task-independent metric and a task-dependent metric; and
combining the task-independent metric and the task-dependent metric to solve wireless communication tasks.

2. The method of claim 1, wherein the wireless channel model is trained offline at a network device operably coupled to the electronic device.

3. The method of claim 1, wherein the task-independent data comprises noiseless wireless channel data.

4. The method of claim 1, wherein determining a task-independent metric and a task-dependent metric comprises:
performing Maximum A Posteriori (MAP) estimation to determine a target information for a wireless communication task based on a gradient ascent optimization;
calculating, by the wireless channel model, a gradient of logarithmic probability of the target information for a wireless communication task; and
calculating a gradient of logarithmic probability of observing the task-dependent data given the target information, the task-dependent data indicative of the target information, observed at the electronic device, being linearly transformed by a task-dependent matrix and corrupted by a noise.

5. The method of claim 1, further comprising:
determining a target information for a wireless communication task based on an iterative sampling procedure by:
defining a number of iterative steps;
initializing a sample target information as a noise;
updating the sample target information based on the task-independent metric and task-dependent metric at each iterative step; and
determining that the target information is last updated sample target information at last iterative step.

6. The method of claim 1, wherein the wireless communication tasks comprise channel estimation and the task-dependent data is a noisy wireless channel indicative of a noiseless wireless channel, observed at the electronic device, being linearly transformed by an identity matrix and corrupted by a noise, and wherein the method further comprises:
calculating, by the wireless channel model, a gradient of logarithmic probability of the noiseless wireless channel;
calculating a gradient of logarithmic probability of observing the noisy wireless channel given the noiseless wireless channel;
updating a sample noiseless wireless channel based on the gradients for a defined number of iterations; and
determining the noiseless wireless channel based on last updated sample noiseless wireless channel at last iteration.

7. The method of claim 1, wherein the wireless communication tasks comprise channel prediction and the task-dependent data is a noisy primary cell channel indicative of a noiseless primary cell channel, observed at the electronic device, being linearly transformed by a subsampling operator and corrupted by a noise, and wherein the method further comprises:
determining the noiseless primary cell channel in frequency domain based on Maximum A Posteriori (MAP) estimation and a gradient ascent optimization; and
predicting a secondary cell channel in the frequency domain based at least in part on the determined noiseless primary cell channel.

8. An electronic device comprising:
memory configured to receive a wireless channel model trained based on task-independent data; and
a processor operably coupled to the memory, the processor configured to:
obtain task-dependent data;
determine, based on the wireless channel model and the task-dependent data, a task-independent metric and a task-dependent metric; and
combine the task-independent metric and the task-dependent metric to solve wireless communication tasks.

9. The electronic device of claim 8, wherein the wireless channel model is trained offline at a network device operably coupled to the electronic device.

10. The electronic device of claim 8, wherein the task-independent data comprises noiseless wireless channel data.

11. The electronic device of claim 8, wherein to determine a task-independent metric and a task-dependent metric, the processor is further configured to:
perform Maximum A Posteriori (MAP) estimation to determine a target information for a wireless communication task based on a gradient ascent optimization;
calculate a gradient of logarithmic probability of the target information for a wireless communication task via the wireless channel model; and
calculate a gradient of logarithmic probability of observing the task-dependent data given the target information, the task-dependent data indicative of the target information, observed at the electronic device, being linearly transformed by a task-dependent matrix and corrupted by a noise.

12. The electronic device of claim 8, wherein:
the processor is further configured to determine a target information for a wireless communication task based on an iterative sampling procedure, and
to determine a target information for a wireless communication task based on an iterative sample procedure, the processor is further configured to:
define a number of iterative steps;
initialize a sample target information as a noise;
update the sample target information based on the task-independent metric and task-dependent metric at each iterative step; and
determine that the target information is last updated sample target information at last iterative step.

13. The electronic device of claim 8, wherein:
the wireless communication tasks comprise channel estimation and the task-dependent data is a noisy wireless channel indicative of a noiseless wireless channel, observed at the electronic device, being linearly transformed by an identity matrix and corrupted by a noise, and
the processor is further configured to:
calculate a gradient of logarithmic probability of the noiseless wireless channel via the wireless channel model;
calculate a gradient of logarithmic probability of observing the noisy wireless channel given the noiseless wireless channel;
update a sample noiseless wireless channel based on the gradients for a defined number of iterations; and
determine the noiseless wireless channel based on last updated sample noiseless wireless channel at last iteration.

14. The electronic device of claim 8, wherein:
the wireless communication tasks comprise channel prediction and the task-dependent data is a noisy primary cell channel indicative of a noiseless primary cell channel, observed at the electronic device, being linearly transformed by a subsampling operator and corrupted by a noise, and
the processor is further configured to:
determine the noiseless primary cell channel in frequency domain based on Maximum A Posteriori (MAP) estimation and a gradient ascent optimization; and
predict a secondary cell channel in the frequency domain based at least in part on the determined noiseless primary cell channel.

15. A non-transitory computer readable medium embodying a computer program, the computer program comprising program code that, when executed by a processor of an electronic device, causes the electronic device to:
receive a wireless channel model trained based on task-independent data;
obtain task-dependent data;
determine, based on the wireless channel model and the task-dependent data, a task-independent metric and a task-dependent metric; and
combine the task-independent metric and the task-dependent metric to solve wireless communication tasks.

16. The non-transitory computer readable medium of claim 15, wherein the wireless channel model is trained offline at a network device operably coupled to the electronic device.

17. The non-transitory computer readable medium of claim 15, wherein the task-independent data comprises noiseless wireless channel data.

18. The non-transitory computer readable medium of claim 15, wherein the program code that, when executed by the processor of the electronic device, causes the electronic device to determine a task-independent metric and a task-dependent metric comprises program code that, when executed by the processor of the electronic device, causes the electronic device to:
perform Maximum A Posteriori (MAP) estimation to determine a target information for a wireless communication task based on a gradient ascent optimization;
calculate a gradient of logarithmic probability of the target information for a wireless communication task via the wireless channel model; and
calculate a gradient of logarithmic probability of observing the task-dependent data given the target information, the task-dependent data indicative of the target information, observed at the electronic device, being linearly transformed by a task-dependent matrix and corrupted by a noise.

19. The non-transitory computer readable medium of claim 15, further comprising program code that, when executed by the processor of the electronic device, causes the electronic device to:
determine a target information for a wireless communication task based on an iterative sampling procedure,
wherein the program code that, when executed by the processor of the electronic device, causes the electronic device to determine a target information for a wireless communication task based on an iterative sampling procedure comprises program code that, when executed by the processor of the electronic device, causes the electronic device to:
define a number of iterative steps;
initialize a sample target information as a noise;
update the sample target information based on the task-independent metric and task-dependent metric at each iterative step; and
determine that the target information is last updated sample target information at last iterative step.

20. The non-transitory computer readable medium of claim 15, wherein:
the wireless communication tasks comprise channel estimation and the task-dependent data is a noisy wireless channel indicative of a noiseless wireless channel, observed at the electronic device, being linearly transformed by an identity matrix and corrupted by a noise, and
the non-transitory computer readable medium further comprises program code that, when executed by the processor of the electronic device, causes the electronic device to:
calculate a gradient of logarithmic probability of the noiseless wireless channel via the wireless channel model;
calculate a gradient of logarithmic probability of observing the noisy wireless channel given the noiseless wireless channel;
update a sample noiseless wireless channel based on the gradients for a defined number of iterations; and
determine the noiseless wireless channel based on last updated sample noiseless wireless channel at last iteration.
